(19) United States
(12) Patent Application Publication
(10) Pub. No.: US 2001/0032806 A1
(43) Pub. Date: Oct. 25, 2001

(54) Birdseed mixture separator

(76) Inventor: J. Esteban Flores, Owasso, OK (US)

Correspondence Address: HOVEY,WILLIAMS, TIMMONS & COLLINS, Suite 400, 2405 Grand, Kansas City, MI, 64108, US

(21) Appl. No.: 09/765,748

(22) Filed: Jan. 19, 2001

Related U.S. Application Data
(60) Provisional application No. 60/176,780, filed on Jan. 19, 2000.

(51) Int. Cl. B07B 4/06

(52) U.S. Cl. 209/138; 209/149

(57) ABSTRACT

A birdseed mixture separator includes an upright shell separation chamber in which shells are separated from shelled and unshelled seeds. The seed mixture is supplied to the chamber from a hopper by a supply line configured to reduce the density of the mixture as it flows to the chamber. The seed mixture is introduced into the chamber above an air inlet opening through which airflow is forced by a blower. The airflow is directed upwardly through the mixture causing the shells to be suspended in the airflow, and the seeds drop downwardly through the chamber as gravity predominates over any lifting force provided by the airflow. The seeds fall through a seed outlet and into an open top seed collection drawer, while the shells are directed through an upwardly spaced shell outlet. The airflow is vented through an air outlet spaced horizontally from the shell outlet and configured to prevent shells from passing therethrough. The shells fall by gravity through a downcomer and into an open top shell collection container.

### RELATED APPLICATION

The Inventor hereby claims the benefit under Title 35 United States Code, § 119(e) of application for U.S. Pat. Ser. No. 60/176,780 filed Jan. 19, 2000, which is hereby incorporated by reference herein.

### BACKGROUND OF THE INVENTION

1. Field of the Invention

The present invention relates generally to seed mixture separators for separating shells from shelled and unshelled seeds. More particularly, the present invention concerns a seed mixture separator that effectively separates shells from seeds by placing the seed mixture in a free fall condition and forcing air upwardly through the mixture, whereby the aerodynamic characteristics of the shells cause them to be suspended in the airflow while the seeds fall downwardly.

2. Discussion of Prior Art

Seed mixtures are used in various types of animal feed and, in virtually every instance, loose shells are preferably not presented to the animal. For example, a domesticated animal (such as a bird, reptile or mammal) often has a diet including a seed mixture (comprising various unshelled seeds and grains) which desirably does not include unnourishing shells (i.e., husks). The husks may be present in the mixture originally provided to the pet but become increasingly prevalent in the mixture as the pet feeds. That is to say, the animal is capable of stripping the shell from the seed but often deposits the shell back into the feed container. Shelled seeds, as well as unshelled seeds originally present in the mixture or inadvertently returned to the container, become progressively difficult to find as the container fills with shells.

It is therefore desirable to have a seed mixture separator operable to separate shells from unshelled and shelled seeds. Those ordinarily skilled in the art will appreciate that a number of animal seed mixtures also include processed food morsels that preferably remain in the feed. Seed mixture separators are also useful in commercial or industrial applications such as pet stores, breeder facilities, zoos, etc. However, conventional devices for separating shells from shelled and unshelled seeds are problematic. Particularly, it is believed that existing separators do not precisely separate shells from seeds, such that seeds are often discarded with the shells and/or shells often remain in the mixture. Furthermore, known seed mixture separators have complex and expensive constructions.

### SUMMARY OF THE INVENTION

The present invention concerns a seed mixture separator including a chamber wall that defines an upright shell separation chamber extending between a seed outlet and an upwardly disposed shell outlet. The chamber wall presents a seed mixture supply opening disposed upwardly from the seed outlet, as well as an air inlet spaced downwardly from the mixture supply opening. An air pump causes air to enter the chamber via the air inlet. At least a portion of the chamber between the air inlet and the mixture supply opening is at least substantially vertical, and the seed mixture entering the chamber through the mixture supply opening is consequently placed in a free fall condition. Airflow in the vertical portion of the chamber (which could be the entire chamber) is directed upwardly therethrough and past the shell outlet, causing shells to be suspended in the airflow and thereby carried through the shell outlet. Because shelled and unshelled seeds do not have the aerodynamic lift qualities of the shells, the seeds are not carried through the shell outlet but rather eventually fall downwardly through the seed outlet.

Another aspect of the present invention is the methodology in separating shells from shelled and unshelled seeds. The seed mixture is placed in a free fall condition and air is directed upwardly through the mixture, causing shells to be suspended in the upward airflow and seeds to fall downwardly against the airflow.

Other aspects and advantages of the present invention will be apparent from the following detailed description of the preferred embodiment and the accompanying drawing figures.

### BRIEF DESCRIPTION OF THE DRAWING FIGURES

A preferred embodiment of the invention is described in detail below with reference to the attached drawing figures, wherein:

FIG. 1 is a perspective view of a preferred birdseed mixture separator constructed in accordance with the principles of the present invention;

FIG. 2 is a perspective view of the opposite side of the separator, with the seed collection drawer and shell collection container being partly removed and parts being broken away to reveal internal details of construction;

FIG. 3 is a top plan view of the separator;

FIG. 4 is a vertical cross-sectional view of the separator taken generally along line 4-4 of FIG. 3, particularly illustrating the separator in operation;

FIG. 5 is a top plan view of an alternative birdseed mixture separator constructed in accordance with the principles of the present invention; and

FIG. 6 is a vertical cross-sectional view of the alternative separator.

### DETAILED DESCRIPTION OF THE PREFERRED EMBODIMENT

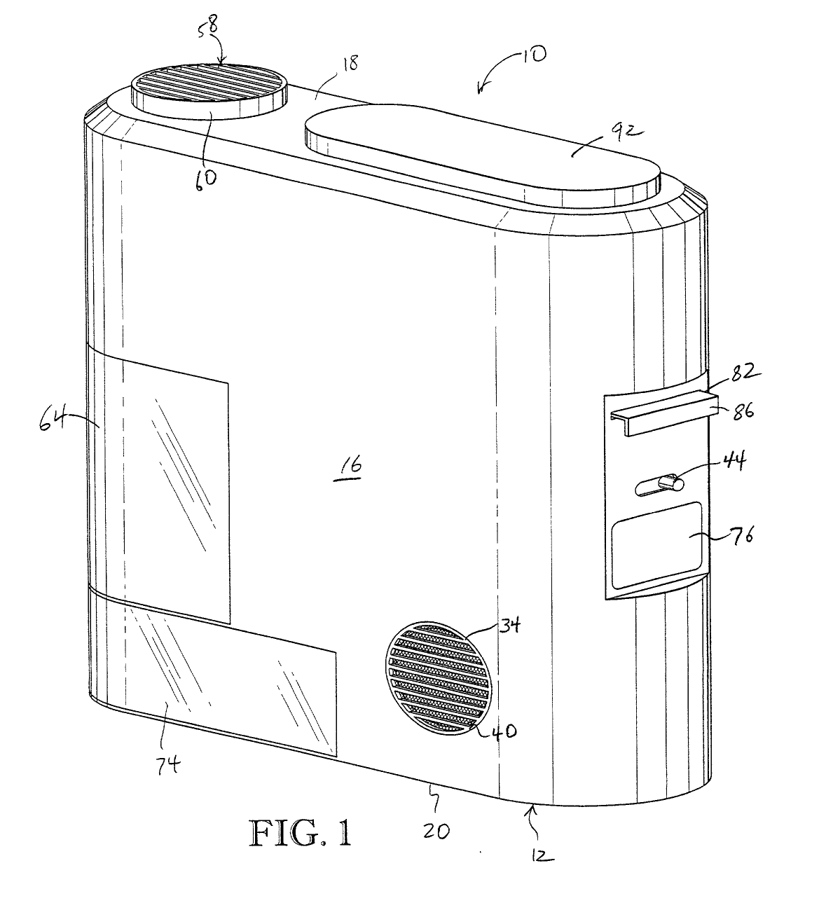

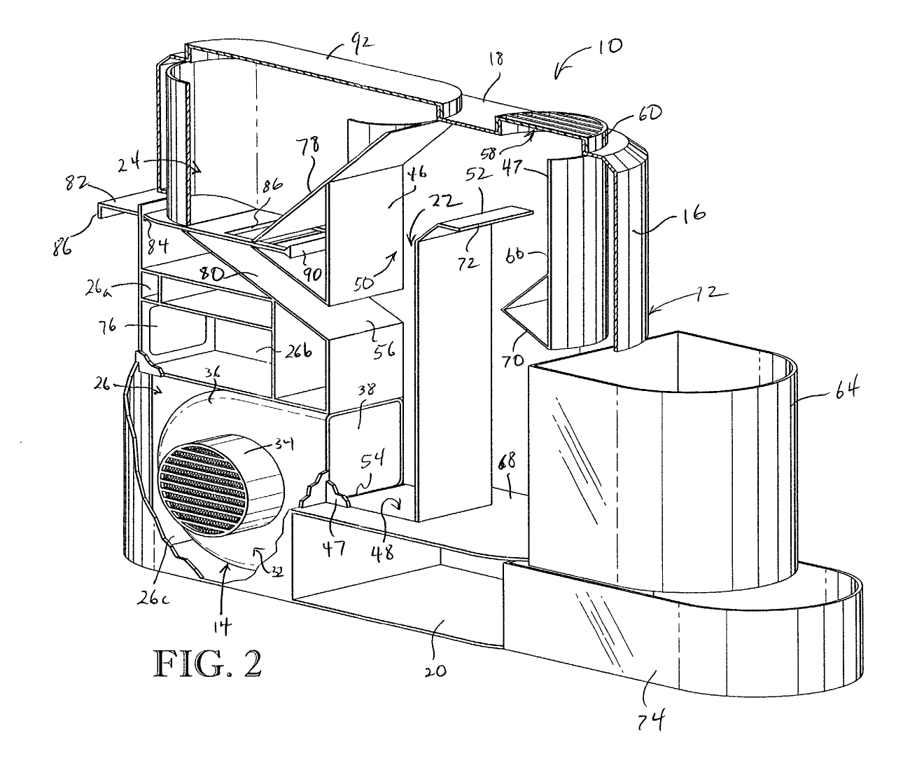

Turning initially to FIG. 1, the seed mixture separator 10 selected for illustration generally includes a housing 12, in which mixture separation occurs, and a blower assembly 14 (see FIG. 2) for facilitating the separation. The description of the illustrated separator 10 will, for exemplary purposes only, focus on its use as a birdseed mixture separator; however, those ordinarily skilled in the art will appreciate that the principles of the present invention are equally applicable to various other seed mixtures (e.g., mammal or reptile feed).

The illustrated housing 12 includes an oval-shaped side wall 16 extending between a top wall 18 and bottom wall 20, although various other housing constructions are within the scope of the present invention. The housing 12 also preferably includes numerous internal walls that serve to provide numerous components and features of the separator 10, as will subsequently be described. It is generally noted that the housing 12 further includes a shell separation chamber 22 in which separation of the seed mixture occurs, a seed mixture supply 24 for delivering seed mixture to the shell separation chamber 22, a blower assembly compartment 26 adjacent the chamber 22, a seed accumulator 28 in which separated shelled and unshelled seeds are collected, and a shell accumulator 30 in which separated shells are collected (see FIG. 4). The housing 12 is preferably formed of molded plastic sections (e.g., a pair of housing sections snap-fit or bonded together along a generally vertical attachment margin), although other suitable materials (e.g., wood, metal, etc.) maybe used. It may desirable to form certain portions of the housing 12 of a transparent or see-through material so that proper operation of the separator 10 can be visually confirmed, although a housing formed entirely of an opaque material is entirely within the ambit of the present invention.

The blower assembly 14 includes a blower 32 that, in the illustrated embodiment, is of the centrifugal blower variety; however, the principles of the present invention are equally applicable to various other types of air pumps (e.g., other blowers or a vacuum downstream from the separation chamber 22). It is only necessary that the separator be provided with an air pump capable of providing the desired airflow through the separation chamber 22, as will be described. If desired, the air pump may be variable speed for accommodating different seed mixtures.

The illustrated blower 32 has a relatively standard construction and, for the sake of brevity, will not be described in detail herein. It shall be sufficient to explain that the illustrated blower 32 includes a central air inlet 34 through which air enters the blower 32, a volute 36 containing the impeller (not shown), and an air outlet 38 extending tangentially from the volute 36. As is customary, the air inlet 34 is grated and provided with a filter. A motor (also not shown) is also provided to drive the impeller (typically a squirrel cage fan). As shown in FIG. 1, the side wall 16 of the housing 12 includes an opening 40 receiving the blower inlet 34 and thereby permitting airflow to the blower 32. One suitable blower is available from Nippon Densan Corp. of Japan as Nidec Gamma28 Model A34342-16, 12 VDC @18 AMP (5×25 W), distributed through RADIO SHACK as Catalog No.273-260 in its Catalog for the year 2000.

The blower assembly 14 further includes a power source 42 and a switch 44 (e.g., see FIG. 4). In the usual manner, the switch 44 is electrically interposed between the blower 32 and power source 42 to permit user control over blower operation. The switch 44 is conventional and, in the illustrated embodiment (see FIG. 1), comprises a toggle switch that opens or closes when shifted side-to-side.

Returning to the housing 12, the shell separation chamber 22 is defined by a chamber wall 46 made up of opposed portions of an oval-shaped internal wall 47 and a pair of internal cross-walls extending therebetween (see FIGS. 2 and 4). In this embodiment, the chamber wall presents a straight, vertical tube having a generally square cross-sectional shape. The opposite ends of the tubular chamber wall 46 are open to present a lower seed outlet 48 and an upper shell outlet 50. The seed outlet 48 preferably communicates directly with the seed accumulator 28, while the shell outlet shell outlet 50 communicates with the shell accumulator 30 via a crossover tube 52. An air supply opening 54 defined in the chamber wall 46 directly communicates with the blower outlet 38, although the principles of the present invention are equally applicable to an air supply opening that is spaced from the blower outlet such that a conduit is required to intercommunicate the two. In fact, the blower assembly need not be contained within the housing 12 as illustrated, but rather the blower may, for example, alternatively be separate from the housing and be provided with a hose that is removably connected to the housing during separator operation. It if further noted that the air supply opening 54 is preferably downstream (relative to the desired direction of airflow) or spaced upwardly from the seed outlet 48 as illustrated. However, the principles of the present invention are equally applicable to positioning the blower outlet upstream from the seed outlet so that the seed outlet is also in essence the air supply opening.

The chamber wall 46 further has defined therein a mixture supply opening 56 communicating with the mixture supply 24. The mixture supply opening 56 is spaced upwardly from the air inlet 54 so that seed mixture entering the chamber 22 is exposed to an upward airflow. In the illustrated embodiment, the openings 54 and 56 are located along the same side of the chamber 22; however, it is entirely within the ambit of the present invention to vary the relative positions of the openings 54 and 56 around the longitudinal axis of the chamber 22 (e.g., the openings 54 and 56 could alternatively be diametrically opposed). The seed mixture supply opening 56 is preferably located below the shell outlet 50, although vertically aligning or positioning of the seed mixture supply opening upwardly from the shell outlet is possible.

It is particularly noted that the shell outlet 50 is located at the top of the illustrated separation chamber 22, and this is most preferred as shells would likely become trapped within any portion of the chamber located above the shell outlet (at least during operation of the separator and, once the blower is deactivated, the trapped shells would likely fall into the seed accumulator). For similar reasons, the seed outlet 48 is preferably located at the bottom of the separation chamber 22. The generally linear, tubular shape of the chamber wall 46 is also most desirable. Specifically, the preferred vertical nature of the illustrated separation chamber 22 ensures that seed mixture introduced therein is placed in a free fall condition. As will be described, the free fall condition of the seed mixture and the upward airflow through the mixture provides effective and precise mixture separation. It is only necessary for the seed mixture be in a free fall condition for a period sufficient to permit adequate exposure to the upward airflow and thereby desired mixture separation, with the period likely varying depending on the mixture and airflow characteristics. It may therefore be possible for only a portion of the chamber 22 between the air inlet 40 and mixture supply opening 56 to be configured to cause the seed mixture to be placed in a free fall condition. For example, the portion of the chamber wall 22 extending between the air inlet 40 and the supply opening 56 maybe vertical, while the remaining portions of the chamber 22 (i.e., any portion of the chamber extending between the mixture supply opening and the shell outlet and between the air inlet and seed outlet) are curved or obtuse relative to vertical. A zigzag shaped chamber (or portion of the chamber extending between the air inlet and mixture supply opening) is also within the scope of the present invention. Again, it is nonetheless most desirable to have the vertical, tubular chamber wall 46 defining the vertical chamber 22.

As previously noted, a crossover tube 52 projects from the shell outlet 50 to the shell accumulator 30. The crossover tube 52 serves not only to transfer the shells from the chamber 22 to the accumulator 30, but the tube 52 also directs the airflow and suspended shells laterally away from the chamber 22. Furthermore, the illustrated crossover tube 52 also facilitates downward movement of the shells into the accumulator 30.

The lateral displacement of the shells and airflow provided by the tube 52 is desirable because of the illustrated arrangement of the shell accumulator 30. Particularly, the accumulator 30 extends alongside the separation chamber 22, and the illustrated embodiment relies on gravity to deposit the separated shells in the accumulator. An air vent or outlet 58 is defined in the housing 12 to permit the airflow to be exhausted therefrom. It will be appreciated that venting of the airflow permits gravity to be the predominating influence over the shells and the shells consequently fall downwardly. The lateral displacement of the shells and airflow before the latter is vented prevents the shells from simply falling back into the separation chamber 22. However, it is only necessary for the air outlet 58 to not be directly over the shell outlet 50 but spaced therefrom and over the shell accumulator. For example, one suitable alternative air outlet arrangement (not shown) could involve an air outlet spaced above the shell outlet along a common vertical axis, with a shell and airflow transfer tube extending between the shell and air outlets and a shell catch being located below the air outlet but above the shell outlet.

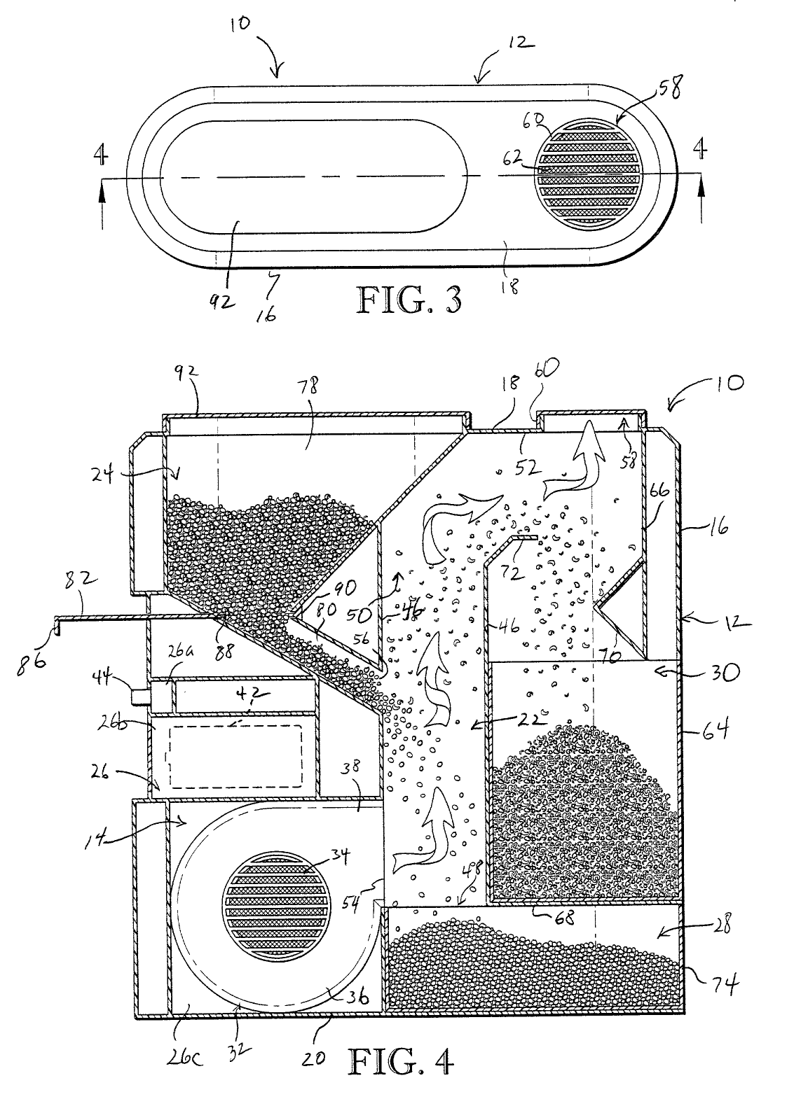

In the illustrated embodiment, the air outlet 58 is presented in the top wall 18 of the housing 12 directly over the shell accumulator 30 (see FIG. 4). Particularly, a grated removable cap 60 retains a filter 62 in a spanning relationship with the outlet 50 (see FIG. 3). The cap 60 and filter 62 prevent shells and other large debris from exiting the housing 12. It is noted that the downward influence on shell movement provided by the crossover tube 52 reduces the risk of premature filter clogging.

The illustrated shell accumulator 30 includes are movable shell container 64 (see FIG. 2) and a downcomer 66 extending between the air outlet 58 and container 64 (see FIG. 4). The shell container 64 preferably presents an open top and is dimensioned to fit snugly in a complemental opening of the side wall 16. The container 64 is preferably formed of a translucent material so that the user can visually determine when the container is full of shells. The container 64 rests against a horizontal wall 68 and the adjacent section of the chamber wall 46 when in the shell collecting position (shown in FIG. 4). The housing 12 is preferably configured to at least substantially prevent airflow out of the container 64 (the container 64 is preferably slidable into and out of the shell collecting position with any gaps between the container 64 and adjacent housing walls being minimal) so that airflow from the crossover tube 52 vents at least primarily at the air outlet 58. As will be appreciated, pneumatic sealing is more important for the seed mixture supply 24 and the seed accumulator 28 than the shell accumulator 30, as minimal airflow through the shell accumulator 30 will likely only assist with shell movement into the container 64. The downcomer 66 preferably extends along a vertical axis and includes a triangular projection 70 that assists in preventing upward backflow of the shells out of the container 64. An inwardly projecting lip 72 presented by the crossover tube 52 also assists in prevent such untoward backflow.

The container 64 and downcomer 66 are preferably located under the air outlet 58 simply to take advantage of the downward gravitational movement of the shells. However, the container may alternatively be spaced laterally or upwardly from the air outlet 58 (e.g., the downcomer could alternatively be obtuse relative to vertical and/or a shell conveyor could be provided to feed the shells to the container). It is most preferable, however, to have an upright downcomer (need not be vertical) that permits the shells to separate from the airflow and be influenced downwardly by gravity. It is also possible to eliminate the removable container and replace it with fixed container (not shown) having a door (also not shown) that can be opened to permit shells to be dumped from the container. The accumulated shells may alternatively be poured through the air outlet 58 simply by removing the cap and 60 and filter 62.

The seed accumulator 28 similarly includes a removable drawer 74 slidably received between the internal horizontal wall 68 and the bottom wall 20 of the housing 12. The seed collecting drawer 74 fits snugly within an opening defined in the side wall 16. The seed drawer presents an open top that communicates directly with the seed outlet 48. As discussed with respect to the shell accumulator 30, this arrangement takes advantage of the of the downward gravitational movement of the seeds, although the drawer may alternatively be located laterally or upwardly away from the seed outlet (e.g., a seed conveyor could be provided to feed the seed from the outlet to the seed collection trough). The seed accumulator may also alternatively comprise a fixed, nonremovable container that can be selectively accessed to permit seeds collected therein to be dumped therefrom. As noted, the housing 12 is preferably configured to prevent substantial airflow out of the seed accumulator 28, thereby blocking forced air from the blower 32 from passing through the seed outlet 48. This facilitates the desired direction of airflow (i.e., upwardly through the separation chamber 22) and consequently lessens the likelihood of shells being blown down into the seed accumulator 28.

The seed mixture supply 24 can be any suitable arrangement for delivering seed mixture to the separation chamber 22 via the mixture supply opening 56. In the illustrated embodiment, the seed mixture supply 24 includes an open top hopper 78 in which seed mixture is contained. The hopper 78 is preferably funnel-shaped to facilitate complete emptying of the seed mixture. A supply line 80 extends between the hopper 78 and supply opening 56, and a sliding gate valve 82 is provided generally at the junction between the hopper 78 and line 80. As perhaps best shown in FIG. 2, the gate valve 82 comprises a plate projecting through a slotted opening 84 in the side wall 16 and presenting a handle 86 in the form of a depending flange. An aperture 88 defined in the plate permits seed mixture to flow therethrough, and a stop lug 90 prevents the plate from being inadvertently removed.

The supply line 80 preferably extends at an obtuse angle relative to vertical, and the angular orientation of the supply line is most preferably at least thirty-five degrees (35°) relative to vertical. It is believed that the preferred angular orientation of the supply line 80 ensures continuous and smooth flow of seed mixture therethrough (i.e., the risk of the mixture frictionally catching on the line is reduced). It is also believed that the angular orientation of the supply line 80 facilitates density reduction of the mixture before it enters the chamber 22. Such density reduction is further facilitated by the relative dimensions of the valve aperture 88 and the cross-section of the supply line 80. It is particularly noted that the aperture 88 essentially defines the outlet of the hopper 78, and this outlet is smaller in area than the cross-section of the supply line. Those ordinarily skilled in the art will appreciate that density reduction of the seed mixture facilitates separation within the chamber 22. The angular orientation of the supply line 80 can also be used to control the rate at which the seed mixture is supplied to the chamber 22, although the use of the gate valve 82 virtually eliminates the need for this design consideration.

The hopper 78 projects downwardly from the top wall 18 of the housing 12. A lid 92 removably connected to an upstanding flange of the top wall 18 is provided to cover the hopper 78. The lid 92 and flange are preferably configured to prevent at least substantially all airflow through the top of the hopper. Limiting any airflow out of the hopper 78 to no more than a minimal amount is desirable so as to reduce the risk of air-induced seed mixture backflow within the supply line 80.

The blower assembly compartment 26 is simply designed to accommodate the illustrated blower assembly 14. In particular, the compartment 26 includes an upper switch sub-compartment 26a, a intermediate power source sub-compartment 26b, and a lower blower sub-compartment 26c. The switch 44 and blower 32 are suitably fixed within their respective sub-compartments 26a and 26b. The power source sub-compartment 26b is provided with a removable cover 76 (FIGS. 1 and 2) for permitting replacement of the power source 42 when necessary. It will be appreciated that the blower assembly may alternatively receive power from a standard wall outlet and, in such an instance, the power source sub-compartment 26b and cover 76 could be eliminated. Note, the blower sub-compartment 26b is defined in part by the chamber wall 46 and the air supply opening 54 directly communicates the separation chamber 22 and sub-compartment 26b. As previously noted, the blower assembly compartment 26 maybe eliminated altogether if separator 10 alternatively includes an exterior blower (not shown) connectable to the housing 12.

The operation of the separator 10 should be apparent from the foregoing description. It shall therefore be sufficient to explain that the blower 32 is activated by toggling the switch 44 and seed mixture is then supplied to the separation chamber 22 by opening the valve 82 (at least partly aligning the aperture 88 with the hopper 78 and supply line 80). As perhaps best shown in FIG. 4, the density of the mixture is reduced at is flows toward the chamber 22, thereby facilitating mixture separation. Once the mixture enters the chamber 22 it is placed in a free fall condition and exposed to the upwardly directed air stream generated by the blower assembly 14. The housing 12 is configured to facilitate the upward direction of airflow. As noted, the seed accumulator 28 is at least substantially sealed and therefore the air will naturally flow from the air supply opening 54 to the air outlet 58. Moreover, the empty shells of the mixture typically have an aerodynamic lift quality causing the shells to be suspended in the air stream. That is, notwithstanding the fact that the shells may have a similar specific gravity as the seeds, the lifting influence within the chamber 22 is greater than any gravitational force and shells are consequently suspended within the moving air stream. It may also be said that the separator 10 does not rely on specific gravity separation but aerodynamic separation, whereby similarly weighted items having different aerodynamic lift qualities are separated. On the other hand, the shelled and unshelled seeds have very little, if any, lift qualities and they consequently fall by gravity against the airflow. The seeds pass through the seed outlet 48 and collect within the drawer 74, while the shells are carried by the airstream through the shell outlet 50 and crossover tube 52. As the air is exhausted through the outlet 58, the gravitational force on the shells predominates over any lifting influence and the shells drop into the container 64.

It will be appreciated that the airflow through the chamber 22 to effect precise mixture separation will vary depending on the blower construction and specifications and chamber dimensions. These components are simply interrelated to effect the desired separation. For example, if a higher volume blower is used, a separation chamber having a cross-sectional area and possibly a length greater than that illustrated will likely be required.

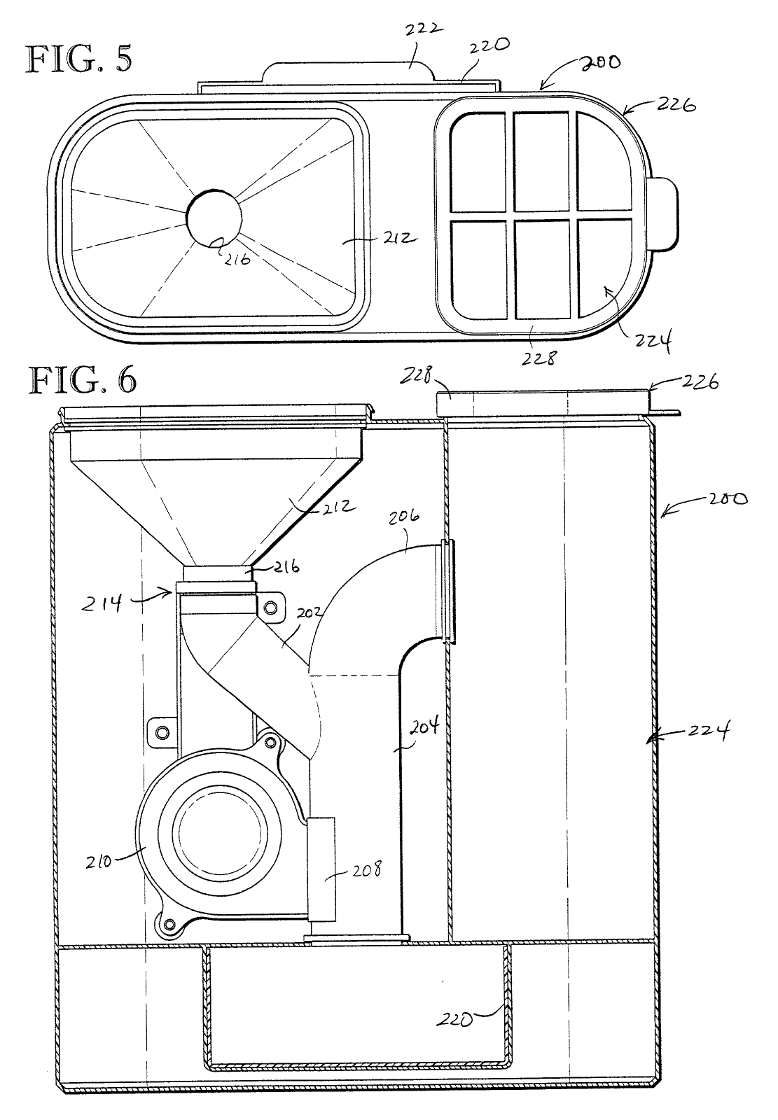

As noted on numerous occasions above, the principles of the present invention are equally applicable to various other seed mixture separator constructions as long as the inventive features are utilized. One such alternative is illustrated in FIGS. 5 and 6, wherein the alternative separator 200 is very similar in concept to the first embodiment shown in FIGS. 1-4. It shall therefore be sufficient to describe the separator 200 primarily with respect to distinctions over the separator 10.

Particularly, the supply line 202, chamber wall 204, crossover tube 206, and blower outlet 208 are generally circular in cross-sectional shape. Moreover, these components have similar diametrical dimensions. It is believed that such a construction provides relatively low airflow losses, thereby reducing the power requirements for the blower 210, and increasing the efficiency of separation.

Although not illustrated, the hopper 212 is provided with a lid for covering the open top thereof. It is also noted that the seed mixture supply 214 is provided with a valve (not shown) for controlling the rate of mixture supply, although the rate may alternatively be controlled by the size of the hopper outlet 216 and the angle of the supply line 202.

The seed collecting drawer 220 is located centrally in the housing and includes a handle 222 for facilitating removal thereof. The shell accumulator 224 comprises a fixed, non-removable container that projects upwardly beyond the crossover tube 206. The top of the container defines the air vent 226, which includes a removable cap 228 and filter (not shown). Operation of the separator 200 will likely need to be stopped once the empty shells in the accumulator 224 reach a height equal to the bottom margin of the cross-over tube 206, unless the seed drawer 220 fills up first. Emptying of the shell container 224 involves removing the cap 228 and filter and dumping the seeds through the open top of the container 224.

As noted above, precise separation of the mixture will likely depend on the mixture and airflow characteristics. The separator 200 has been tested with a mixture including sunflower and millet seeds and shells. The illustrated separator 200 has a chamber diameter of approximately one inch and the blower 210 is the same as the blower 32 identified hereinabove. The illustrated separator also has a blower outlet with a diameter of about one inch and the upper entry opening of the supply line 202 has a oval shape of about one inch by three-quarters of an inch.

When applying a voltage of twelve (12) VDC to the blower 210, the separator 200 properly separated 99% of the millet seeds and shells and 66-85% of the sunflower seeds and shells. No millet seeds were transferred to the shell accumulator 224 and only 1% of the total millet shells were found in the seed drawer 220. No sunflower seeds were transferred to the shell accumulator 224 and 15-33% of the total sunflower shells were found in the seed drawer 220.

When applying a voltage of sixteen and one-half (16.5) VDC to the blower 210, the separator 200 properly separated about 90% of the millet seeds and shells and about 90% of the sunflower seeds and shells. About 5% of the total millet seeds were transferred to the shell accumulator 224 and no millet shells were found in the seed drawer 220. No sunflower seeds were transferred to the shell accumulator 224 and about 5% of the total sunflower shells were found in the seed drawer 220.

When applying a voltage of nineteen and one-half (19.5) VDC to the blower 210, the separator 200 properly separated about 75-85% of the millet seeds and shells and about 99% of the sunflower seeds and shells. About 15-25% of the total millet seeds were transferred to the shell accumulator 224 and no millet shells were found in the seed drawer 220. No sunflower seeds were transferred to the shell accumulator 224 and about 1% of the total sunflower shells were found in the seed drawer 220.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A seed mixture separator for separating shells from shelled and unshelled seeds, said separator comprising:
a housing presenting an upright shell separation chamber extending between a seed outlet and an upwardly disposed shell outlet,
said housing including a seed mixture supply operable to contain the seed mixture,
said seed mixture supply communicating with the chamber via a mixture supply opening disposed upwardly from the seed outlet; and
an air pump operable to cause air to enter the chamber via an air inlet spaced downwardly from the mixture supply opening, with the housing being configured to facilitate airflow upwardly through the chamber and past the shell outlet,
at least a portion of the chamber between the air inlet and the mixture supply opening being at least substantially vertical so as to cause the seed mixture passing therethrough to be placed in a free fall condition.

2. A seed mixture separator as claimed in claim 1,
said housing including a chamber wall that defines the separation chamber,
said chamber wall being solid except for the seed outlet, shell outlet, mixture supply opening and air inlet defined therein.

3. A seed mixture separator as claimed in claim 2,
said chamber wall presenting an open-ended tube, with the shell and seed outlets each being defined by a respective one of the tube ends.

4. A seed mixture separator as claimed in claim 3,
said tube extending along a vertical, longitudinal axis.

5. A seed mixture separator as claimed in claim 3,
said tube having a cornerless cross-sectional shape.

6. A seed mixture separator as claimed in claim 1,
said air pump comprising a blower upstream from the air inlet and operable to inject air into the chamber via the air inlet.

7. A seed mixture separator as claimed in claim 1,
said mixture supply including a seed mixture hopper and a supply line intercommunicating the hopper and the separation chamber.

8. A seed mixture separator as claimed in claim 7,
said hopper being funnel shaped.

9. A seed mixture separator as claimed in claim 7,
said hopper presenting an open top,
said seed mixture supply including a lid that covers the top of the hopper in a manner to prevent air-induced backflow of seed mixture from the separation chamber to the hopper.

10. A seed mixture separator as claimed in claim 7,
said supply line being oblique relative to vertical.

11. A seed mixture separator as claimed in claim 1,
said housing including a seed drawer that presents a seed inlet opening and is removably positionable in a seed-collecting position in which the seed inlet opening communicates with the seed outlet.

12. A seed mixture separator as claimed in claim 11,
said housing being configured to at least substantially prevent airflow through the seed outlet when the seed drawer is in the seed-collecting position.

13. A seed mixture separator as claimed in claim 1,
said mixture supply opening being spaced downwardly from the shell outlet.

14. A seed mixture separator as claimed in claim 13,
said seed outlet being upstream from the air inlet relative to the facilitated direction of airflow.

15. A seed mixture separator as claimed in claim 1,
said housing presenting an air outlet that communicates with the shell outlet and is spaced therefrom in the facilitated direction of airflow,
said air outlet being configured to prevent shells from passing therethrough.

16. A seed mixture separator as claimed in claim 15,
said air outlet being spaced horizontally from the shell outlet,
said housing including a shell collection container that presents a shell inlet opening spaced below and in communication with the air outlet.

17. A seed mixture separator as claimed in claim 16,
said housing including a crossover tube extending between the shell outlet and the air outlet,
said housing further including an upright downcomer extending between the air outlet and the shell inlet opening.

18. A seed mixture separator for separating shells from shelled and unshelled seeds, said separator comprising:
a chamber wall defining an upright shell separation chamber extending between a seed outlet and an upwardly disposed shell outlet,
said chamber wall presenting a seed mixture supply opening disposed upwardly from the seed outlet,
said chamber wall further presenting an air inlet spaced downwardly from the mixture supply opening; and
an air pump operable to cause air to enter the chamber via the air inlet,
at least a portion of the chamber wall between the air inlet and the mixture supply opening being configured to cause the seed mixture to be in a free fall condition, with airflow within said at least a portion of the chamber wall being directed upwardly therethrough and past the shell outlet.

19. A seed mixture separator as claimed in claim 18,
said chamber wall being solid except for the seed outlet, shell outlet, mixture
supply opening and air inlet defined therein.

20. A seed mixture separator as claimed in claim 19,
said chamber wall presenting an open-ended tube, with the shell and seed outlets each being defined by a respective one of the tube ends.

21. A seed mixture separator as claimed in claim 20,
said tube extending along a vertical, longitudinal axis.

22. A seed mixture separator as claimed in claim 20,
said tube having a cornerless cross-sectional shape.

23. A seed mixture separator as claimed in claim 18,
said air pump comprising a blower upstream from the air inlet and operable to inject air into the chamber via the air inlet.

24. A seed mixture separator as claimed in claim 18;
a seed mixture hopper; and
a supply line intercommunicating the hopper and the seed mixture supply opening.

25. A seed mixture separator as claimed in claim 24,
said hopper being funnel shaped.

26. A seed mixture separator as claimed in claim 24,
said hopper presenting an open top; and
a lid operable to cover the top of the hopper in a manner to prevent air-induced backflow of seed mixture from the separation chamber to the hopper.

27. A seed mixture separator as claimed in claim 24,
said supply line being oblique relative to vertical.

28. A seed mixture separator as claimed in claim 18; and
a seed drawer presenting a seed inlet opening and being removably positionable in a seed-collecting position in which the seed inlet opening communicates with the seed outlet.

29. A seed mixture separator as claimed in claim 18,
said mixture supply opening being spaced downwardly from the shell outlet.

30. A seed mixture separator as claimed in claim 29,
said seed outlet being upstream from the air inlet relative to the direction of airflow.

31. A seed mixture separator as claimed in claim 18; and
an air outlet communicating with the shell outlet and being spaced therefrom in the direction of airflow,
said air outlet being configured to prevent shells from passing therethrough.

32. A seed mixture separator as claimed in claim 31,
said air outlet being spaced horizontally from the shell outlet; and
a shell collection container presenting a shell inlet opening spaced below and in communication with the air outlet.

33. A seed mixture separator as claimed in claim 32;
a crossover tube extending between the shell outlet and the air outlet; and
an upright downcorner extending between the air outlet and the shell inlet opening.

34. A seed mixture separator as claimed in claim 18,
said at least a portion of the chamber wall being at least substantially vertical.

35. A seed mixture separation method for separating shells from shelled and unshelled seeds, said seed mixture separation method comprising the steps of:
(a) placing seed mixture into a free fall condition; and
(b) forcing air upwardly through the mixture so that shells are suspended in the airflow and seeds fall downwardly through the airflow.

36. A seed mixture separation method as claimed in claim 35,
step (a) including the step of delivering seed mixture from a seed mixture hopper to an upright shell separation chamber.

37. A seed mixture separation method as claimed in claim 36,
step (a) including the step of at least substantially pneumatically sealing the separation chamber except for an air inlet and an upwardly spaced air outlet.

38. A seed mixture separation method as claimed in claim 36,
step (a) including the step of reducing the density of the seed mixture as it is delivered from the hopper to the separation chamber.

39. A seed mixture separation method as claimed in claim 35,
step (b) including the step of activating an air pump.

40. A seed mixture separation method as claimed in claim 35; and
(c) collecting the downwardly falling seeds in a seed collection drawer.

41. A seed mixture separation method as claimed in claim 35,
step (a) including the step of delivering seed mixture to an upright shell separation chamber;
(c) directing the shells through a shell outlet at the top of the separation chamber and then away from the shell outlet; and
(d) after step (c), exhausting the airflow through an air outlet configured to prevent shells from passing therethrough and collecting the shells below the air outlet.

42. A seed mixture separation method as claimed in claim 41; and
(e) collecting shells below the air outlet.
